(19) United States
(12) Patent Application Publication
(10) Pub. No.: US 2024/0383055 A1
(43) Pub. Date: Nov. 21, 2024

(54) INSTRUMENTED SAW BLADE

(71) Applicant: Schlumberger Technology Corporation, Sugar Land, TX (US)

(72) Inventors: Jonathan Robert Hird, Cambridge (GB); Andrew David Robinson, Cambridge (GB); Kjell Haugvaldstad, Vanvikan (NO)

(21) Appl. No.: 18/690,720

(22) PCT Filed: Oct. 12, 2022
(86) PCT No.: PCT/US2022/046354

§ 371 Date: Mar. 9, 2024

Related U.S. Application Data
(60) Provisional application No. 63/256,718, filed on Oct. 18, 2021.

(51) Int. Cl. B23D 59/00; B23D 45/00

(52) U.S. Cl. CPC B23D 59/001; B23D 45/003

(57) ABSTRACT

A control system for a saw blade used to cut slots in carbon anodes used in aluminum processing includes an instrument package installed on the saw blade. The instrument package includes one or more sensors used to measure one or more operating characteristics. If the operating characteristics are outside of a threshold operating characteristic. then one or more operating parameters of the saw blade can be adjusted. Example adjustments may be made to the rotational speed or depth of cut of the saw blade. or repair or replacement of cutting elements or the saw blade.

### CROSS-REFERENCE TO RELATED APPLICATIONS

This application claims the benefit of, and priority to, U.S. Patent Application Ser. No. 63/256,718, filed Oct. 18, 2021 and titled “Instrumented Saw Blade”, which application is expressly incorporated herein by this reference in its entirety.

### BACKGROUND

Aluminum production often involves electrolysis of a molten aluminum salt. The electrolysis involves applying an electric current to the molten aluminum salt in the presence of a carbon anode and a graphite covered steel cathode. This process may result in the formation of carbon monoxide, which may bubble on the surface of the carbon anode. To increase the exposed surface area of the carbon anode, slots may be formed in the carbon anode. Such slots may be cast in place while forming the carbon anode. In some situations, such slots may be cut into the carbon anode with a saw blade.

### SUMMARY

In some embodiments, an instrument package for a saw blade includes a support structure that is connectable to the saw blade. A sensor is coupled to the support structure and configured to measure an operating characteristic of the saw blade. Local or remote storage is configured to receive measurements of the operating characteristic from the sensor. The storage is located in a housing of the support structure or in a remote location but with communication from the sensor. One or more power sources are configured to provide power to the sensor and the storage. In some embodiments, the instrument package or a portion thereof is connected to the saw blade. In some embodiments, the sensor is connected to a cutting element of the saw blade.

In some embodiments, a method for collecting cutting information includes installing an instrument package on a saw blade. During operation of the saw blade, operating characteristics of the saw blade are connected using the instrument package. Based on the operating characteristics, one or more operating parameters of the saw blade are adjusted.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a carbon anode cutting system, according to at least one embodiment of the present disclosure;

FIG. 2-1 and FIG. 2-2 are representations of a saw blade, according to at least one embodiment of the present disclosure;

FIG. 3 is a representation of a cutting element, according to at least one embodiment of the present disclosure;

FIG. 4-1 is a representation of an instrument package, according to at least one embodiment of the present disclosure;

FIG. 4-2 is a representation of the instrument package of FIG. 4-1 being installed on a saw blade, according to at least one embodiment of the present disclosure;

FIG. 5 is a representation of an instrument package control system, according to at least one embodiment of the present disclosure;

FIG. 6 is a flowchart of a method for collecting cutting information, according to at least one embodiment of the present disclosure; and

FIG. 7 is a flowchart of a method for collecting cutting information, according to at least one embodiment of the present disclosure.

### DETAILED DESCRIPTION

This disclosure generally relates to devices, systems, and methods for instrumenting a saw blade used to cut slots in carbon anodes used during aluminum production. During use, the saw blade may heat up, wobble, vibrate, and so forth. Left unchecked, this may cause damage to the saw blade and/or the carbon anode. An instrument package connectable to the saw blade includes one or more sensors to sense an operating condition of the saw blade. The one or more sensors may include a thermocouple or other temperature sensor, a strain gauge, a vibration sensor, an accelerometer, any other sensor, and combinations thereof. In some embodiments, the sensed operating condition may be used to adjust an operating parameter of the saw blade, such as rotational rate, advancement rate, depth of cut, any other operating parameter, and combinations thereof. This may help to reduce wear and tear on the saw blade, increase operating life, decrease operating costs, increase cutting slot accuracy, and so forth.

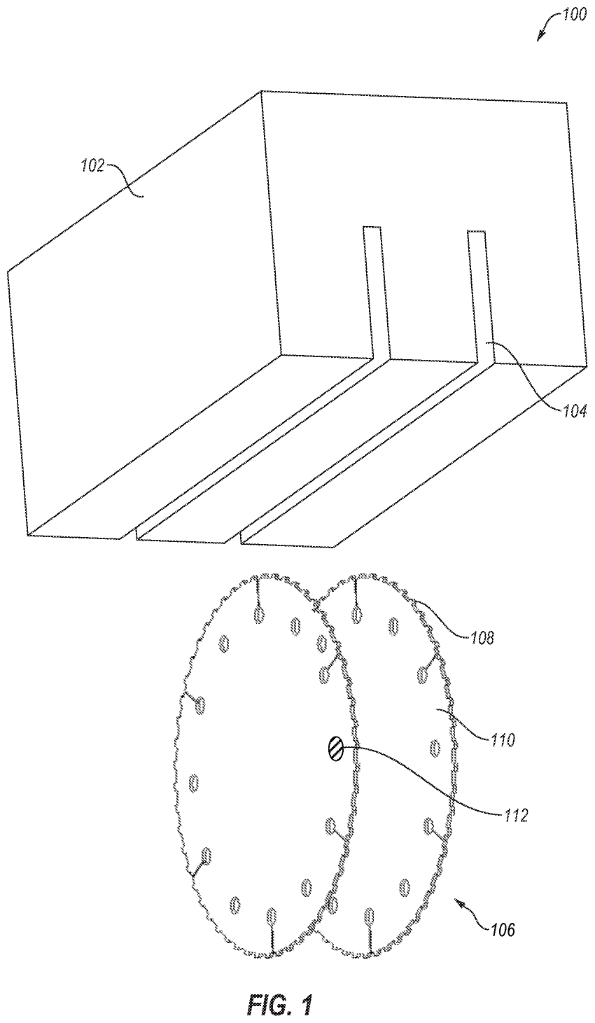

FIG. 1 is a representation of a carbon anode system 100, according to at least one embodiment of the present disclosure. The carbon anode system 100 includes a carbon anode 102. Aluminum production may include electrolysis of a molten aluminum salt or other aluminum compound. The electrolytic bath may include the carbon anode 102 and a carbon-coated steel cathode. When an electric current is applied to the solution, oxygen reacts with the carbon anode 102 to form gaseous carbon dioxide, which bubbles off of the carbon anode 102. In some situations, the bubbles of carbon dioxide may create a buffer between the electrolysis solution and the carbon anode 102, thereby reducing the contact area of the solution with the carbon anode 102.

To increase the surface area of the carbon anode, thereby mitigating the effects of the bubbling carbon dioxide, the carbon anode 102 may include one or more slots 104. This may provide more area for the solution to contact the carbon anode 102. This may further provide pathways for the bubbles to escape the carbon anode 102. The slots 104 may be formed in any manner. For example, the slots 104 may be formed when casting the carbon anode 102. Casting the slots 104 in the carbon anode may be simple and reduce the amount of post-processing of the carbon anode 102. However, cast slots 104 may be wide and have higher stress concentrations at the ends. This may result in premature failure of the carbon anode 102 and/or a carbon anode 102 with less material for use in aluminum processing.

In some situations, the slots 104 may be cut into the carbon anode 102. For example, the slots 104 may be cut into the carbon anode 102 using one or more rotating saw blades 106. The saw blades 106 may include one or more cutting elements 108. As will be discussed in further detail herein, the cutting elements 108 may be connected to a body 110 of the saw blade 106. The cutting elements 108 may include a removable or replaceable cutting insert. As the saw blade 106 rotates, the cutting insert may come into contact with the carbon anode 102. This may cause the cutting insert to erode or degrade, thereby forming the slot 104.

The one or more saw blades 106 may be operated with one or more operating parameters. The operating parameters may be the parameters by which the saw blades 106 are operated to cut the slots 104. In some embodiments, the operating parameters may include rotational rate (e.g., RPM), which may be the rate at which the rotating saw blade 106 is rotated. In some embodiments, the operating parameters may include an advance rate, which may be the rate at which the rotating saw blade 106 is advanced through the carbon anode 102. In some embodiments, the operating parameters may include an advance pressure, which may be the pressure applied to the saw blade 106 when moving the saw blade 106 through the carbon anode 102. In some embodiments, the operating parameters may include any other parameter used to control the one or more saw blades 106 to cut the slots 104.

During operation (e.g., while the saw blade 106 is rotating and/or engaging the carbon anode 102), the saw blade 106, including the body 110 and the cutting elements 108, may experience wear and/or other damage. An instrument package 112 may be used to monitor one or more operating conditions of the saw blade 106. The instrument package 112 may include one or more sensors. The one or more sensors may sense the one or more operating conditions. For example, the one or more sensors may include a thermocouple, which may be used to measure a temperature of the body 110 and/or the cutting elements 108. In some examples, the one or more sensors may include a strain gauge, which may be used to measure strain experienced by the body 110 and/or the cutting elements 108. In some examples, the one or more sensors may include an accelerometer, which may be used to measure the motion of the saw blade 106. In some examples, the one or more sensors may include a gas sensor, which may be used to measure the production of gases while drilling the carbon anode 102.

In some embodiments, the measurements obtained by the instrument package 112 may be used to control operation of the one or more saw blades 106. For example, based a temperature measurement from a thermocouple, a control system may adjust a rotational rate or depth of the saw blade 106 (e.g., reduce the rotational rate or depth if the temperature is above a temperature threshold, increase the rotational rate r temperature if the temperature is below a temperature threshold). This may allow an operator to maintain operation of the one or more saw blades 106 within a pre-determined set of operating conditions.

In the embodiment shown, the carbon anode 102 includes two slots 104. In some embodiments, a single saw blade 106 may cut the two slots 104. In some embodiments, such as the embodiment shown, two saw blades 106 may be used to cut the two slots 104. In some embodiments, a single saw blade 106 may include an instrument package 112. Each saw blade 106 in a carbon anode system 100 may have similar properties, cutting elements, structure, and so forth. And each saw blade 106 may operate under the same or similar operating conditions. Using a single instrument package 112 on a single saw blade 106 may help reduce instrumentation costs and complexity because sensed operating conditions on a first saw blade 106 may be the same as or similar to sensed operating conditions on a second saw blade 106.

In some embodiments, each saw blade 106 may include an instrument package 112. For example, a first saw blade 106 may include a first instrument package 112, and a second saw blade 106 may include a second instrument package 112. In some embodiments, the operating conditions may be different on different saw blades 106. For example, manufacturing differences in the saw blades 106 and/or variations in the body of the carbon anode 102 may result in different operating differences on different saw blades 106. Including an instrument package 112 on different saw blades 106 may help to measure and track the different operating conditions on each saw blade 106. This may allow the operator to tailor the operating parameters to the particular conditions of each saw blade 106. In some embodiments, the properties of the first saw blade 106 and the second saw blade 106 may be different, and including an instrument package 112 on each saw blade 106 may help to monitor the operating conditions on each saw blade 106.

In some embodiments, each instrument package 112 may have the same sensors. For example, each instrument package 112 may have the same number and type of sensors. In some embodiments, the sensors on instrument packages 112 on different saw blades 106 may be different. For example, the first instrument package 112 may have a different number and/or different types of sensors than the second instrument package 112. This may allow the instrument package 112 to be tailored to a particular saw blade 106, application, set of operating conditions, carbon anode 102, or any other particular use-case.

In some embodiments, multiple saw blades 106 may operate with the same operating parameters. For example, the two saw blades 106 shown in FIG. 1 may rotate at the same rotational rate, advance with the same advancement rate, cut at the same depth, and/or advance with the same advancement pressure. In some embodiments, multiple saw blades 106 may be rotated using the same motor, axle, mandrel, or other rotary element. In some embodiments, a control system may control the operating parameters of the saw blades 106 based on the sensed operating conditions from the instrument package 112. For example, if a sensor indicates that the temperature of the body 110 and/or cutting elements 108 is higher than a temperature threshold, then the control system may adjust the rotational rate, the depth, the rate of advance, or the advancement pressure of the saw blades 106. In some embodiments, if a first instrument package 112 on a first saw blade 106 detects an operating parameter that is above an operating threshold (or out of an operating threshold range), the control system may adjust the operating parameters of each saw blade in the carbon anode system 100. In this manner, the slots 104 may be cut in the carbon anode 102 at the same rate.

In some embodiments, multiple saw blades may operate with different operational parameters. For example, the two saw blades 106 shown in FIG. 1 may rotate with different rotational rates, cut at different depths, advance with different advancement rates, and/or advance with different advancement pressures. In some embodiments, the different saw blades 106 may be rotated using different motors, axles, mandrels, or other rotary elements. In some embodiments, a control system may control the independent operation of both saw blades 106 based on the sensed operating conditions of the saw blades 106. In this manner, if the operating conditions of the different saw blades 106 are different, then the control system may change the operating parameters until the operating conditions are within a particular operating threshold (or operating threshold range). This may help to maintain each saw blade 106, thereby extending the operational life of each individual saw blade 106.

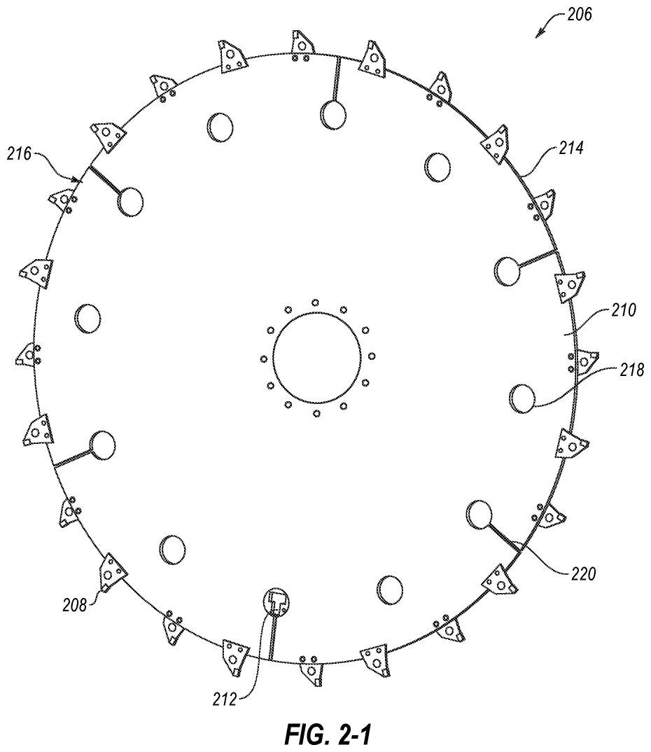

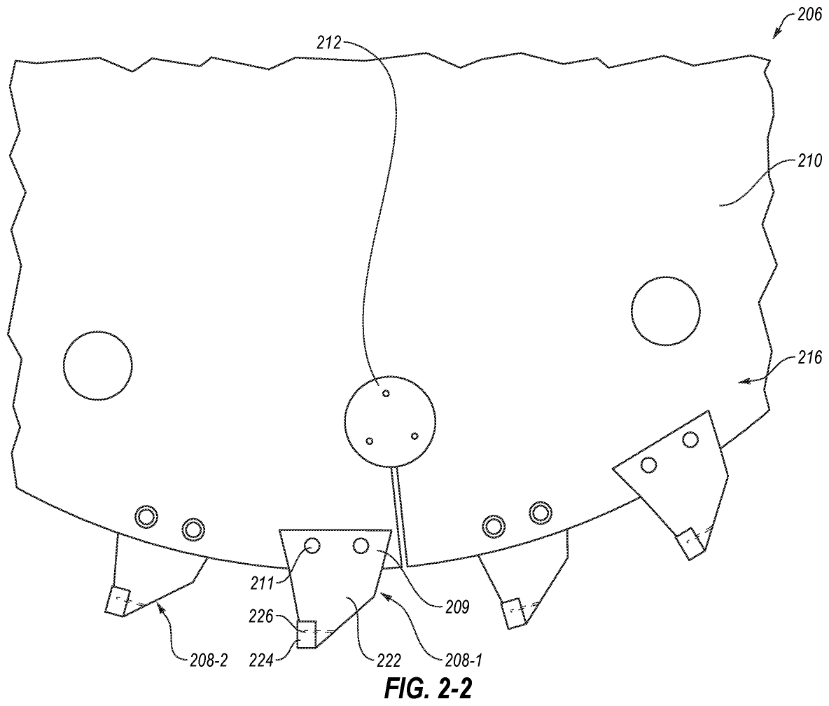

FIG. 2-1 is a representation of a saw blade 206, according to at least one embodiment of the present disclosure. The saw blade 206 includes a body 210. In some embodiments, the saw blade 206 may be generally cylindrical, and the body 210 may include a front surface 216 (e.g., the surface in the view shown in FIG. 2-1), a rear surface opposite the front surface 216, and a circumferential surface 214 that extends between the front surface 216 and the rear surface. In some embodiments, one or more cutting elements 208 may be connected to the saw blade 206 at the circumferential surface 214. As the saw blade 206 rotates, the one or more cutting elements 208 may engage the carbon anode (e.g., the carbon anode 102 of FIG. 1) to cut the slots (e.g., the slots 104). In at least some embodiments, the cutting elements 208 are positioned around the circumferential surface 214 while a body, substrate, or other portion thereof is coupled to the front surface 216, the rear surface, or both the front surface 216 and the rear surface.

The circumferential surface 214 may have any suitable diameter, although in an application such as anode slotting, the diameter may be between 750 mm and 1500 mm, although in certain cases the diameter may be less than 750 mm or greater than 1500 mm. Such a saw blade 206 may therefore have a plurality of cutting elements 208. In some embodiments, there may be 20, 30, 50, 70, 100, or more cutting elements 208 around the circumferential surface 214. For instance, an example saw blade 206 may have a diameter of 1340 mm and have 50 to 60 cutting elements 208 to make a slot that is between 5 mm and 25 mm in width (e.g., a 9 mm wide slot).

In some embodiments, the body 210 may include one or more bores 218 that extend through the body 210 from the front surface 216 to the rear surface. In some embodiments, a bore 218 may include a saw slot 220 from the bore 218 to the circumferential surface 214. In some embodiments, the bores 218 and/or the saw slots 220 may help to control the vibrational and/or rotational dynamics of the saw blade 206 during operation.

In some embodiments, as discussed herein, the saw blade 206 may include one or more instrument packages 212 connected to the body 210. In some embodiments, an instrument package 212 may be installed in and/or extend through a bore 218 in the saw blade 206. In some embodiments, the bore 218 may provide room for the instrument package 212 without increasing an operational thickness of the saw blade 206.

In some embodiments, the saw blade 206 may include multiple bores 218. In some embodiments, the saw blade 206 may include multiple instrument packages 212. In some embodiments, multiple instrument packages 212 may be installed in multiple different bores 218. In some embodiments, the saw blade 206 may include any number of instrument packages 212, including 1, 2, 3, 4, 5, 7, 10, 15, or more instrument packages, or any number therebetween. In some embodiments, different instrument packages 212 may be evenly distributed around the body 210 of the saw blade 206. For example, two instrument packages 212 may be installed in diametrically opposite (e.g., 180° apart) bores 218, three instrument packages 212 may evenly spaced (e.g., 120° apart) around the body 210 of the saw blade 206, four instrument packages 212 may be evenly spaced (e.g., 90° apart) around the body 210 of the saw blade 206, and so forth. Evenly spacing the instrument packages 212 may help to mass-balance or weight-balance the saw blade 206. In some embodiments, evenly spacing the instrument packages 212 may allow the operator to determine whether a particular measured operating characteristic is representative of the general conditions of the saw blade 206, or whether a particular location or cutting element 208 has a specific operating condition. In this manner, an operator may determine if a particular cutting element 208 or portion thereof is due for repair or replacement, or if the body 210 or other portions need to be generally repaired or replaced.

In some embodiments, instrument packages 212 may be located adjacent (e.g., next to, proximate to) each other. For example, two instrument packages 212 may be located in adjacent bores 218. This may help to collect information about a specific location, area, cutting element 208, or another portion on the saw blade 206.

In some embodiments, the instrument package 212 may be located next to (e.g., adjacent to, proximate to) a particular cutting element 208. For example, the instrument package 212 may be connected to a sensor connectable to the saw blade 206. For example, the sensor may be connectable to the body 210 of the saw blade 206. In some examples, the sensor may be connectable to a cutting element 208 of the saw blade. In some embodiments, the sensor may be connected to the particular cutting element 208. The instrument package 212 may include processing resources, power resources, storage resources, communication resources, and so forth that may be used in conjunction with the sensor on the cutting element 208. This may allow the sensor to collect operating conditions from a location close to the cutting element 208. Information collected closer to the cutting element 208 is typically more representative of the actual operating conditions, thereby improving how closely the measured operating conditions represent the actual operating conditions of the cutting element 208.

Understanding operating condition of the cutting elements 208 and/or the saw blade 206 may help to reduce damage to and/or failure of the cutting elements 208 and/or the saw blade 206. For example, based on the contact with the carbon anode, the cutting elements 208 may heat up. If the temperature of the cutting elements 208 become higher than a temperature threshold, then the cutting element 208 may be more likely to fail, such as through cracking or breaking. A thermocouple on or in a cutting element 208 may help the operator to understand the operating temperature of the cutting element 208. This may allow the operator to control operation of the saw blade 206 to maintain the operating temperature of the cutting element 208 below a particular operating threshold (or within a particular operating threshold range).

In some embodiments, the instrument package 212 may collect and store the measurements (e.g., the measured operating conditions) collected from the sensor on the cutting element 208 on local storage. After operation of the saw blade 206, the operator may retrieve the operating conditions stored in the local storage on the instrument package 212. The operator may then analyze the measured operating conditions and determine whether any changes may be made to the operating parameters.

In some embodiments, the instrument package 212 may include a wireless communication element. In some embodiments, the instrument package 212 may collect and transmit the collected measurements to a remote computing device. This may allow for real-time analysis of the operating conditions of the saw blade 206. In some embodiments, this may allow a drilling operator to establish a feedback loop between the instrument package 212 and the operating parameters to maintain the operating conditions within an operating threshold or operating threshold range. In some embodiments, the wireless communication element may include any wireless communication element that may communicate using any wireless communication protocol, including Wi-Fi, Bluetooth, Zigbee, infrared, any other wireless communication protocol, and combinations thereof. In some embodiments, the wireless communication element may include inductive telemetry. For example, the instrument package 212 may include an inductive power transfer and/or communication element. Pulsing the amplitude of the inductive communication element may allow instrument package 212 to communicate information, which may be connected to a remote computing device. While embodiments of the present disclosure have discussed wireless communication elements, it should be understood that wired communication elements may be used, such as a slip ring or other rotating electrical connection.

In some embodiments, the body 210 may include one or more sensors on the front surface 216, the rear surface, and/or the circumferential surface 214. For example, the body 210 may include one or more strain gauges, which may be used to determine bending stresses on the saw blade 206. Bending stresses on the saw blade 206 may be a result of vibration, wobble, misalignment of the saw blade 206, misalignment of the carbon anode, or any other bending of the body 210. In some embodiments, the strain gauge may detect stresses on the body 210 due to thermal expansion. Detecting bending stresses on the body 210 may help to detect when the body 210 may be close to failure. This may help to prevent a failure during operation, which may damage the carbon anode being cut, cause damage to other operating, and/or injure an operator or worker.

FIG. 2-2 is a representation of a lower portion of the saw blade 206 of FIG. 2-1. As may be understood by one skilled in the art in view of the disclosure herein and the view shown in FIG. 2-2, the saw blade 206 can include a plurality of cutting elements 208. The cutting elements 208 may be connected to the body 210 of the saw blade 206. Optionally, some or all of the cutting elements 208 are positioned around the circumferential surface 214 (see FIG. 2-1) of the body 210 of the saw blade 206. The cutting elements 208 may each be the same and mounted in a same or similar manner or position, although one or more of the cutting elements 208 may be different or may be mounted in other manners. For instance, in FIG. 2-2, the cutting elements 208 are shown as optionally alternating in being mounted to (or in a compartment in) either the front surface 216 or the rear surface 218 of the body 210. In such embodiments, cutters 208-1 may be similar to cutters 208-2, but configured for mounting to opposing faces of the body 210. The cutting elements 208 (including cutting elements 208-1 and 208-2) may be connected to the body 210 of the saw blade 206 with any type of connection. For example, the cutting elements 208 may be bolted, welded, brazed, or otherwise connected to the saw blade 206. In some embodiments, the cutting elements 208 are therefore removably coupled to the saw blade 206, while in other embodiments, the cutting elements 208 are intended for permanent fixture to the saw blade 206.

In some embodiments, the cutting elements 208 may include a substrate 222, an insert 224, or a combination of the substrate 222 and the insert 224. The substrate 222 may be formed from a wear-resistant material such as tungsten carbide or other wear-resistant material. The insert 224 may be formed from an ultrahard material, such as polycrystalline diamond (PCD) or cubic boron nitride (CBN). In some embodiments, the insert 224 may be brazed or otherwise connected to the substrate 222 or a portion of the cutting element 208. In some embodiments, the substrate 222 is removably coupled to a body of the cutting element 208. During operation, the insert 224 may engage or otherwise come into contact with the carbon anode, and may erode, degrade, chip, spall, or otherwise remove material from the carbon anode.

Optionally, the insert 224 has a width about equal to the body 210 of the saw blade 206. The substrate 222 may be about as wide as the saw blade 206, or in some embodiments is thinner. For instance, the substrate 222 may be positioned in a compartment in a front or rear face of the body 210, in a manner that aligns the insert 224 with a center of the circumferential surface 214. Thus, even alternating front and rear-mounted cutting elements 208 may have inserts 224. Of course, in other embodiments, the inserts 224 may be misaligned, or may be wider or thinner than the body 210 of the saw blade 206.

Contact with the carbon anode may cause place stresses on the cutting element 208. For example, contact with the carbon anode may increase the heat of the insert 224 and/or the substrate 222. In some examples, the forces from contact with the carbon anode may crack and/or break the insert 224, the substrate 222, the connection between the cutting element 208 and the body 210, the connection between the insert 224 and the substrate 222, any other portion of the cutting element 208, and combinations thereof. Damage to the cutting element 208 may reduce the effectiveness of the cutting element 208. In some embodiments, damage to the cutting element 208 may result in replacement of the cutting element 208, which may increase the operating cost of the saw blade 206.

To monitor the status of the cutting element 208, the cutting element 208 may include one or more sensors 226. In some embodiments, the sensor 226 may be configured to sense any operating condition of the cutting element 208. For example, the sensor 226 may include a thermocouple that is configured to measure a temperature of the cutting element 208, such as a temperature of the insert 224, the substrate 222, the connection between the cutting element 208 and the body 210, any other part of the cutting element 208, and combinations thereof. In some embodiments, the sensor 226 may be configured to detect strain or other forces on the cutting element 208. For example, the sensor 226 may include a strain gauge configured to detect strain caused by contact of the cutting element 208 with the carbon anode.

As discussed herein, in some embodiments, an instrument package 212 may be installed in the body 210 of the saw blade 206. The instrument package 212 may be connected to the one or more sensors 226. As discussed herein, the instrument package 212 may collect the measured data from the one or more sensors 226, store it locally on local storage, and/or transmit the measured data to a remote computing device.

In some embodiments, the instrument package 212 may collect information from a single sensor located on a single cutting element 208. In some embodiments, a single instrument package 212 may collect information from multiple sensors located on a single cutting element 208. For example, a single cutting element 208 may include a thermocouple and a strain gauge, and the instrument package 212 may collect the measurements from both sensors. In some embodiments, a single instrument package 212 may collect information from sensors located at multiple different cutting elements 208. This may allow a single instrument package 212 to monitor the operating conditions of multiple different cutting elements 208, thereby increasing the amount of measured operating conditions of the saw blade 206. This may allow the operator to determine the general operating condition of the saw blade 206 with increased accuracy or precision.

In some embodiments, the instrument package 212 may include one or more sensors. For example, the instrument package may include one or more accelerometers. The accelerometers may be used to determine the rotational acceleration, wobble, vibration, and other movements experienced by the body 210 of the saw blade 206. In some embodiments, the instrument package may include any other sensors, such as temperature sensors, strain gauges, and so forth.

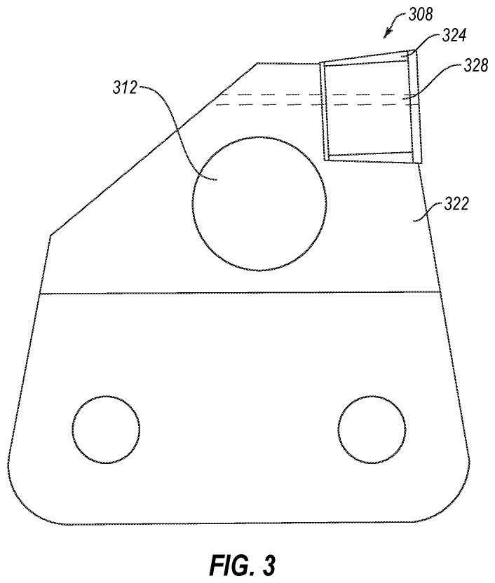

FIG. 3 is a representation of a cutting element 308, according to at least one embodiment of the present disclosure. The cutting element 308 includes an insert 324 connected to a substrate 322. As discussed herein, the cutting element 308 may be configured to connect to a body of a saw blade. During operation, the insert 324 may engage or contact the carbon anode.

In the embodiment shown, the cutting element 308 includes a sensor bore 328. This may allow one or more sensors to be installed in the interior of the cutting element 308. Installing a sensor in the interior of the cutting element 308 may allow the sensor to detect one or more operating conditions of the cutting element 308 while protecting the sensor from erosion by contact with the carbon anode.

In some embodiments, the sensor bore 328 may be drilled into the substrate 322. A sensor may be placed in the sensor bore 328 to detect an operating condition of the substrate 322, thereby allowing the operator to monitor the operating condition of the substrate 322. In some embodiments, the sensor bore 328 may be drilled into the insert 324, thereby allowing the operator to monitor the operating condition of the insert 324. In some embodiments, the sensor bore 328 may be drilled through the substrate 322 and into the insert 324. In some embodiments, the cutting element 308 may include sensor bores 328, and sensors inside of the multiple sensor bores 328 may allow the user to detect the operating condition of the cutting element 308 at multiple locations.

In some embodiments, the cutting element 308 may include one or more sensors located on an outer surface of the cutting element 308. Placing a sensor on the outer surface of the cutting element 308 may decrease the cost of sensor installation on the cutting element 308.

In some embodiments, the cutting element 308 may include an instrument package 312. In some embodiments, the instrument package 312 may be connectable to the cutting element 308. For example, in some embodiments, the instrument package 312 may be connectable or connected to the substrate 322 of the cutting element 308. For example, the instrument package 312 may be connected to an outer surface of the cutting element 308. In some examples, the instrument package 312 may be inserted into a slot or pocket in the substrate 322. Including the instrument package 312 in the cutting element 308 may increase the ease of installation of the instrument package 312 by reducing the wiring used to connect the instrument package 312 to the sensor.

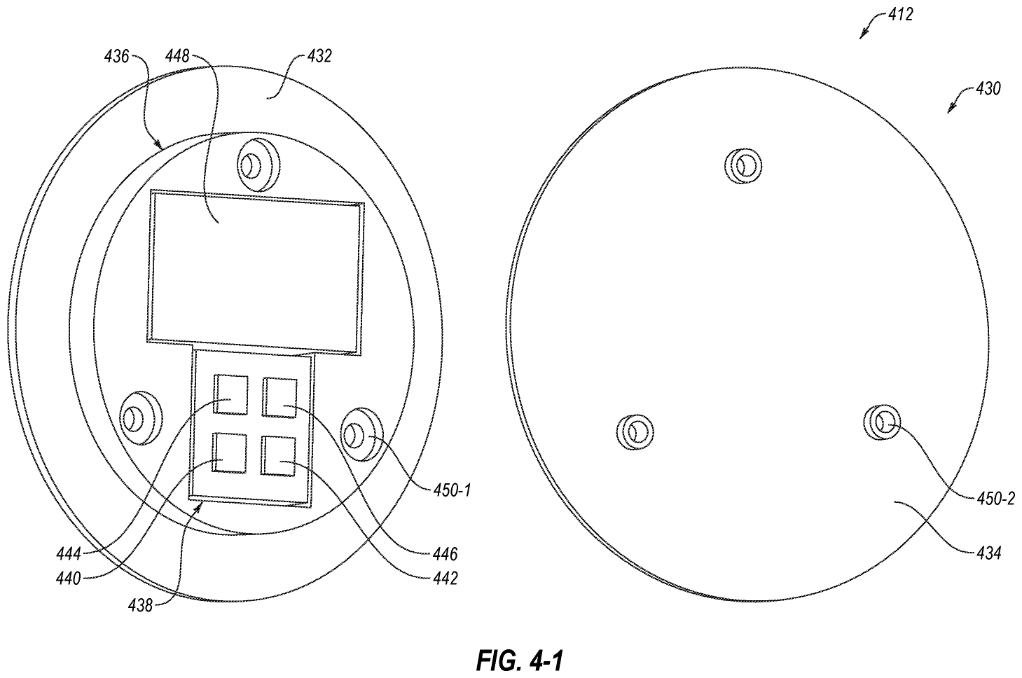

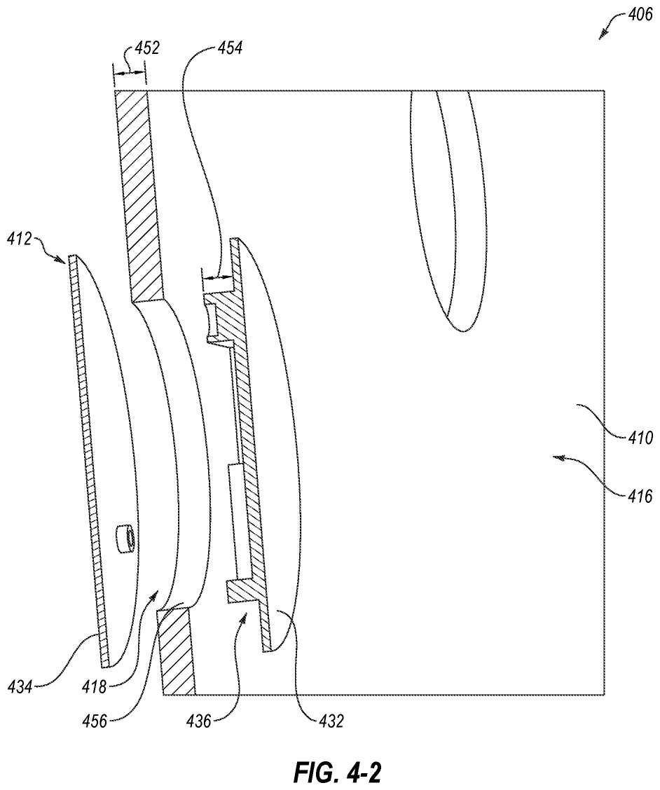

FIG. 4-1 is a representation of an instrument package 412 in an uninstalled position, according to at least one embodiment of the present disclosure. In some embodiments, the instrument package 412 may include a support structure such as housing 430. As discussed herein, the housing 430 may be connectable to a saw blade. Put another way, the housing 430 may be connected to a saw blade such that the instrument package 412 may be secured to the saw blade. In some embodiments, the housing 430 may be connectable to a body of the saw blade.

The housing 430 may include a first portion 432 and a second portion 434. An electronics chassis 436 may be located in the housing 430. The electronics chassis 436 may support or house one or more electronic components. For example, the electronics chassis 436 may include one or more printed circuit boards (PCBs) 438. The PCB 438 may include one or more electronic components, such as a processor 440, memory 442, and so forth. In some embodiments, the PCB 438 may include one or more sensors 444, such as an accelerometer, force sensor, thermocouple, and so forth. As discussed herein, the one or more sensors 444 may be used to monitor the operating conditions of the instrument package 412 and/or the portion of a saw blade to which the instrument package 412 is attached. In some embodiments, the PCB 438 may further include a communication element 446. The communication element 446 may transmit information stored on the memory 442 to a remote computing device. In some embodiments, the processor 440 may control the operation of the one or more sensors 444 and/or any external sensors (e.g., a sensor connected to or inserted into a cutting element, such as the cutting element 208 of FIG. 2-1 and FIG. 2-2).

In some embodiments, the instrument package 412 may include a power source 448. The power source 448 may provide power to the PCB 438 and/or any connected sensors 444, including sensors in communication with the instrument package 412. For example, the power source 448 may provide power to one or more sensors 444 connected to or inserted into a cutting element. In some embodiments, the power source 448 may include a power storage element, such as a battery and/or a super capacitor. A power storage element may be a simple way to provide power. This may help to improve the reliability of the instrument package 412. In some embodiments, the power storage element may be a rechargeable power storage element (e.g., a rechargeable battery). In some embodiments, the rechargeable power storage element may be rechargeable with a wired connection. For example, the rechargeable power storage element may be rechargeable using an electrical slip ring or other rotating wired connection.

In some embodiments, the rechargeable power storage element may be rechargeable with a wireless connection. For example, the wireless charging system may include inductive charging. The inductive charging system may be incorporated into the spindle or hub. The power may be routed through the body of the saw blade to the instrument package 412. In some embodiments, the power source 448 and/or recharging system may be provided by radio frequency (RF) harvesting devices. RF harvesting may harvest the energy from directed RF bands. Wireless charging systems may reduce the number and complexity of the wired connections, thereby simplifying the construction of the instrument package 412.

In some embodiments, the instrument package 412 may include a power generation element. A power generation element may include any power generation element. For example, a power generation element may include an energy harvesting system. As the saw blade moves during operation, a portion of the energy may be harvested by the energy harvesting system and converted into electricity. In some embodiments, the energy harvesting system may include a reciprocating member that reciprocates based on the movement of the saw blade. In some embodiments, the energy harvesting system may include a rotating member that rotates based on the movement of the saw blade. An energy harvesting system may allow for an indefinite power supply to the PCB 438 and/or any connected sensors 444. In some embodiments, the instrument package 412 may include both a rechargeable power storage and an energy harvesting system. This may help to provide an uninterrupted power supply to the instrument package 412.

In some embodiments, the first portion 432 may be connected to the second portion 434. For example, the first portion 432 may include one or more first connectors 450-1. The second portion 434 may include one or more complementary second connectors 450-2. The first portion 432 may be connected to the second portion 434 by connecting the first connectors 450-1 to the second connectors 450-2. In some embodiments, the first connectors 450-1 may be connected to the second connectors 450-2 in any manner, such as a press-fit, a friction fit, an interference fit, a ridge and detente, a mechanical fastener, an adhesive, welding, brazing, any other connection mechanism, and combinations thereof. In some embodiments, the housing 430 may create a seal around the electronics chassis 436. This may help to prevent dust, moisture, or other foreign matter from entering the electronics chassis 436 and damaging the power source 448 and/or the PCB 438.

FIG. 4-2 is a representation of the instrument package 412 from FIG. 4-1 being installed on a saw blade 406. As discussed herein, the instrument package 412 may be installed in a bore 418 in the body 410 of the saw blade 406. Put another way, the instrument package 412 may extend through the bore 418. The first portion 432 may be connected to the second portion 434 across the bore 418. The first portion 432 may be in contact with the front surface 416, and the second portion 434 may be in contact with the rear surface. When the first portion 432 is connected to the second portion 434, the electronics chassis 436 is located inside the bore 418. In some embodiments, the electronics chassis 436 may be sandwiched within the bore 418 between the first portion 432 and the second portion 434.

The body 410 of the saw blade 406 has a body thickness 452. In some embodiments, the body thickness 452 may be any value in a range of 6 mm, 8 mm, 10 mm, 12 mm, 14 mm, 16 mm, 18 mm, 20 mm, 25 mm, 30 mm, or any value therebetween. In some embodiments, the body thickness 452 may be equal to or less than a cutting thickness of the saw blade 406. The electronics chassis 436 has a chassis thickness 454. In some embodiments, the chassis thickness 454 is the same as or less than the body thickness 452. This may allow the electronics chassis 436 to fit within the bore 418. In some embodiments, the instrument package 412 may have a package thickness that may be the total connected thickness of the instrument package 412, including the electronics chassis 436 and the outer plates of the first portion 432 and the second portion 434. As discussed herein, the first portion 432 may be connected to the second portion 434 with a mechanical fastener. The plates on the first portion 432 and the second portion 434 may retain the position of the electronics chassis 436 within the bore 418 by clamping on the front surface 416 and the back surface. In some embodiments, the package thickness may be equal to or less than the cutting thickness of the saw blade 406. This may allow the instrument package 412 to be connected to the body 410 during operation without contacting and/or being damaged by contact with the carbon anode.

In some embodiments, the entirety of the instrument package 412 may be located within the bore 418. Put another way, no portion of the instrument package 412 may extend out of the bore 418. In some embodiments, the instrument package 412 may be directly connected to the inner surface 456 of the bore 418, such as with an adhesive, braze, weld, mechanical fastener, press-fit, friction fit, interference fit, ridge and detente, any other connection mechanism, and combinations thereof. This may help prevent the instrument package 412 from contacting and/or being damaged by contact with the carbon anode.

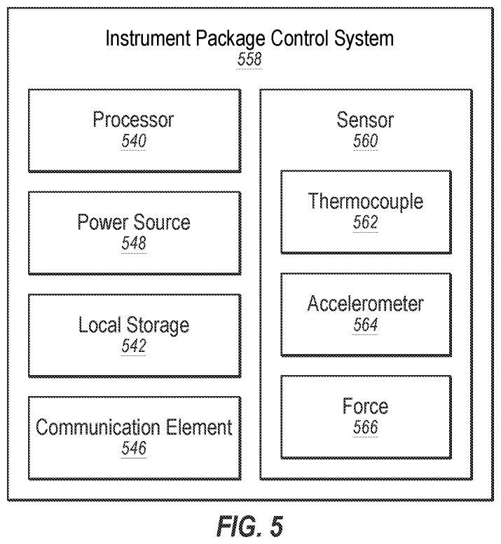

FIG. 5 is a representation of an instrument package control system 558, according to at least one embodiment of the present disclosure. The control system 558 includes a power source 548 that is configured to power the control system 558. A processor 540 controls operation of the control system 558, including the collecting of measurements from one or more sensors 560. Measurements from the sensors 560 may be stored on local storage 542 and/or transmitted to a remote computing device.

The control system 558 includes one or more sensors 560. The sensors 560 may measure or sense the operating condition of the saw blade. As discussed herein, the sensors 560 may include any type of sensor, including a thermocouple 562 configured to measure a temperature of the saw blade and/or connected cutting elements, an accelerometer 564 configured to measure motion of the saw blade and/or connected cutting elements, a force sensor 566 configured to measure strain or other forces on the saw blade and/or connected cutting elements, any other sensor 560, and combinations thereof.

In some embodiments, the processor 540 may provide instructions to the sensors 560 to prepare measurements of the operating condition of the saw blade. In some embodiments, the processor 540 may provide instructions regarding the measuring frequency. In some embodiments, the processor 540 may provide instructions to the local storage 542 to store the measurements from the sensor 560. In some embodiments, the processor 540 may provide instructions to the communication element 546 to communicate the measurements to a remote computing device. The remote computing device may then utilize the transmitted measurements to determine the operating conditions of the saw blade. The remote computing device, and/or an operator, may use the operating conditions to adjust the operating parameters of the saw blade.

In some embodiments, the communication element 546 may receive instructions from the remote computing device to change and/or adjust a measurement schedule for the sensors 560. The processor 540 may receive the instructions and collect measurements according to them. For example, the instructions may instruct the processor 540 to collect measurements from a particular sensor 560, with a particular collection rate, or any other instructions. This may help to focus sensor measurements on a particular portion or area of the saw blade. For example, if a portion of the saw blade appears to be wearing faster than expected, changing the measurement profile may allow the operator to determine when the saw blade or cutting element may fail, and/or to determine a cause for the increased wear.

In some embodiments, the processor 540 may analyze the measurements provided by the sensor 560. For example, the processor 540 may analyze the measurements and determine the operating condition of the saw blade. The processor 540 may store the analysis in the local storage 542. In some embodiments, the analysis may be collected after the blade has stopped operating. In some embodiments, the analysis may be transmitted to the remote computing device using the communication element 546.

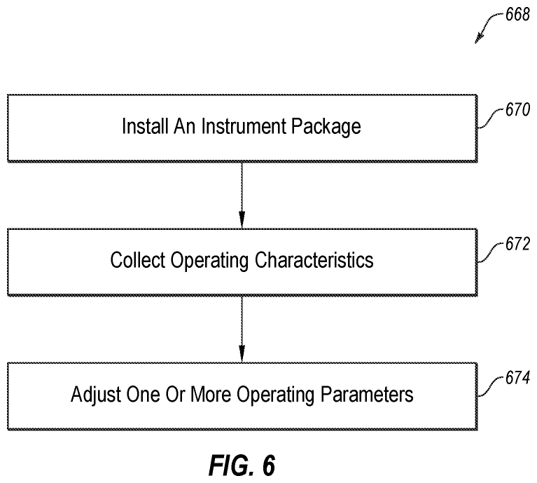

FIG. 6 is a flowchart of a method 668 for collecting cutting information during operation of a saw blade, according to at least one embodiment of the present disclosure. The method 668 may be performed by the instrument package control system 558 of FIG. 5. Put another way, the instrument package control system 558 of FIG. 5 may perform the method 668.

The method 668 may include installing an instrument package on a saw blade at 670. As discussed herein, the instrument package may be installed in a bore in the body of the saw blade. During operation of the saw blade, the control system may collect data about operating characteristics of the saw blade at 672. The operating characteristics may be collected by the instrument package. Based on the collected operating characteristics, the control system may adjust one or more operating parameters of the saw blade at 674. For example, based on the collected operating characteristics, the control system may adjust one of rotational rate, advance rate, advance pressure, depth, any other operating parameter, and combinations thereof.

In some embodiments, collecting the operating characteristics includes collecting temperature information. For example, collecting temperature information may include collecting temperature measurements from a thermocouple or other temperature sensor. The temperature information may be collected from a single location, or from multiple locations to determine a temperature profile of the saw blade. The temperature information may include temperature values in degrees Celsius, degrees Fahrenheit, Kelvin, or any other temperature values. In some embodiments, collecting the operating characteristics includes collecting vibration information (such as from a strain gauge or other vibration sensor). In some embodiments, the vibration information may include vibration frequency, displacement amounts, vibration amplitude, a vibration waveform, any other vibration information, and combinations thereof. In some embodiments, installing the instrument package may include installing the instrument package in a bore in the saw blade. In some embodiments, the method 668 may further include transmitting the operating characteristics to a remote device from the instrument package.

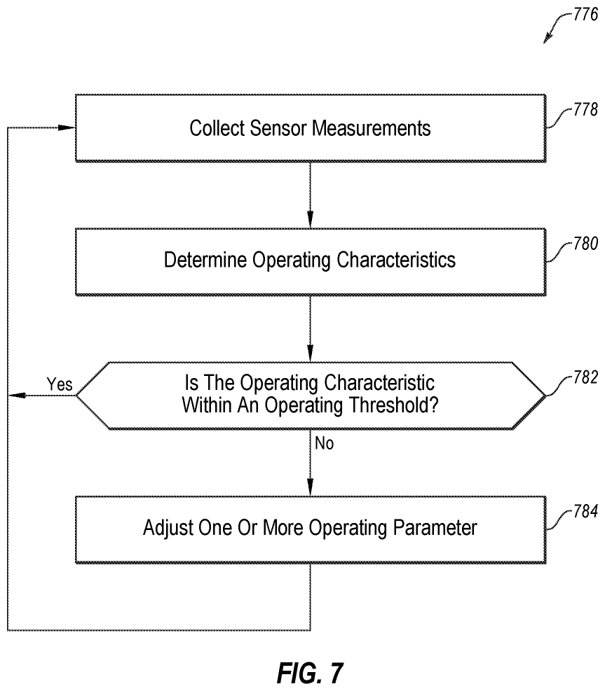

FIG. 7 is a flowchart of a method 776 for controlling operation of a saw blade, according to at least one embodiment of the present disclosure. The method 776 may be performed by the instrument package control system 558 of FIG. 5. Put another way, the instrument package control system 558 of FIG. 5 may perform the method 776.

In accordance with embodiments of the present disclosure, an instrument package on a saw blade may collect one or more sensor measurements at 778. The sensor measurements may be any type of measurements, such as temperature measurements, strain measurements, force measurements, gas measurements (e.g., carbon dioxide, carbon monoxide), any other type of measurements, and combinations thereof. Using the collected measurements, the control system may determine one or more operating characteristics at 780. For example, the control system may determine an operating temperature, rotational rate, vibration profile, wobble, applied force, any other operating characteristic, and combinations thereof. In some embodiments, a processor on the instrument package may determine the operating characteristic. In some embodiments, the measurements may be transmitted to a remote computing device, and the remote computing device may determine the operating characteristics.

In some embodiments, the control system may determine whether the operating characteristic is within an operating threshold or operating threshold range at 782. If the operating characteristic is within the operating threshold, then the control system may continue to collect sensor measurements. This loop may be continued until the operating characteristics are not within the operating threshold.

In some embodiments, if the operating characteristic is not within an operating threshold, then the control system may adjust one or more operating parameters at 784. For example, if the temperature is higher than a temperature threshold, then the control system may reduce a rotational rate, reduce the cutting depth, reduce an advance rate, and/or reduce an advance pressure of the saw blade. In some examples, if the temperature is less than a low temperature threshold, then the control system may increase the rotational rate, increase the cutting depth, increase the advance rate, and/or increase the advance pressure of the saw blade. In some embodiments, if the vibration profile is outside of a threshold vibration profile, the control system may adjust one or more of the operating parameters of the saw blade.

After the one or more operating parameters have been adjusted, the control system may collect additional sensor measurements, and the acts of the method 776 may be repeated. In this manner, a feedback loop may be established between the operating parameters and the sensed and determined operating conditions of the saw blade. This may help to reduce wear and tear, increase the operational lifetime, and reduce operating costs of the saw blade.

In some embodiments, the sensed and determined operating conditions and the operating parameters may be used to train a machine learning model (MLM). The MLM may be trained to identify correlations and/or patterns between the operating conditions and the operating parameters. The output from the MLM may be used to maintain the operating parameters of the saw blade in a state that may increase the operational lifetime of the saw blade.

The embodiments of the instrumented saw blade have been primarily described with reference to wellbore drilling operations; the instrumented saw blades described herein may be used in applications other than the drilling of a wellbore. In other embodiments, instrumented saw blades according to the present disclosure may be used outside a wellbore or other downhole environment used for the exploration or production of natural resources. For instance, instrumented saw blades of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An instrument package for a saw blade, comprising:
a support structure connectable to the saw blade;
a sensor coupled to the support structure and configured to measure an operating characteristic of the saw blade;
storage configured to receive measurements of the operating characteristic from the sensor; and
at least one power source configured to provide power to the sensor and the storage.

2. The instrument package of claim 1, wherein the support structure includes a housing, and the sensor is located in the housing.

3. The instrument package of claim 1, wherein the support structure includes a housing, and the storage is located in the housing.

4. The instrument package of claim 1, wherein the sensor includes at least one of a thermocouple, a strain gauge, or an accelerometer.

5. The instrument package of claim 1, wherein the sensor is connectable to the saw blade.

6. The instrument package of claim 1, further comprising a wireless communication system coupled to at least one of the storage or the sensor and configured to communicate with a remote computing device.

7. The instrument package of claim 1, wherein the at least one power source includes a rechargeable battery.

8. The instrument package of claim 1, wherein the at least one power source includes an energy harvesting system.

9. The instrument package of claim 1, wherein the support structure is connectable to a body of the saw blade.

10. The instrument package of claim 1, wherein the support structure is connectable to a removable cutting element of the saw blade.

11. The instrument package of claim 1, wherein the at least one power source providing power to the storage is coupled to the support structure.

12. An instrumented saw blade, comprising:
a saw blade body having a circumferential surface;
a plurality of cutting elements connected to the circumferential surface; and
an instrument package connected to the saw blade body, the instrument package including a sensor configured to measure an operating characteristic of the instrumented saw blade.

13. The instrumented saw blade of claim 12, wherein the instrument package extends through a bore in the saw blade body.

14. The instrumented saw blade of claim 12, wherein the sensor includes a thermocouple.

15. The instrumented saw blade of claim 14, wherein the thermocouple is connected to at least one of the plurality of cutting elements.

16. A method for collecting cutting information, comprising:
installing an instrument package on a saw blade;
during operation of the saw blade, collecting at least one operating characteristic of the saw blade using the instrument package; and
based on the at least one operating characteristic, adjusting one or more operating parameters of the saw blade.

17. The method of claim 16, wherein collecting the at least one operating characteristic includes collecting at least one of temperature information or vibration information.

18. The method of claim 16, wherein adjusting the one or more operating parameters includes adjusting a rotational rate or cutting depth of the saw blade.

19. The method of claim 16, wherein installing the instrument package includes installing the instrument package in a bore in the saw blade.

20. The method of claim 16, further comprising transmitting the at least one operating characteristic to a remote computing device from the instrument package.
